(19) United States
(12) Patent Application Publication
(10) Pub. No.: US 2025/0087412 A1
(43) Pub. Date: Mar. 13, 2025

(54) TRANSFORMER WINDING AND METHOD FOR CONSTRUCTING TRANSFORMER WINDING

(71) Applicant: EATON INTELLIGENT POWER LIMITED, Dublin (IE)

(72) Inventors: Jianxiong Yu, Shanghai (CN); Cheng Luo, Shanghai (CN); Jiajie Duan, Shanghai (CN); Cheng Wang, Shanghai (CN)

(21) Appl. No.: 18/813,920

(22) Filed: Aug. 23, 2024

(30) Foreign Application Priority Data
Sep. 12, 2023 (CN) 202311175382.7

(51) Int. Cl. H01F 27/32; H01F 27/28; H01F 41/12

(52) U.S. Cl. CPC H01F 27/323; H01F 27/2828; H01F 41/125; H01F 2027/329

(57) ABSTRACT

Provided are a transformer winding and a method for constructing a transformer winding. The transformer winding includes: a lead wire of a winding conductor of the transformer winding; an insulating layer wrapping the lead wire; a ground shielding layer covering a side, close to the winding conductor, of the insulating layer; and a stress grading material layer, which is made of a semi-conductive material, covers a side, away from the winding conductor, of the insulating layer, and is electrically connected to the ground shielding layer, where the stress grading material layer is impedance-matched with the insulating layer.

### RELATED APPLICATIONS

Any and all applications for which a foreign or domestic priority claim is identified in the Application Data Sheet as filed with the present application are incorporated by reference under 37 CFR 1.57 and made a part of this specification. The present application claims the benefit of priority under 35 U.S.C. § 119 (a) to Chinese Patent Application No. 202311175382.7, filed on Sep. 12, 2023, which is hereby incorporated herein by reference in its entirety.

### TECHNICAL FIELD

The present inventive concept relates to the field of transformers, in particular to a transformer winding and a method for constructing a transformer winding.

### BACKGROUND

Medium voltage high-frequency transformers have higher power density and efficiency and lighter weight than replaceable conventional large-volume power frequency transformers. For example, for a 50 Hz 100 KW transformer, when its frequency is increased to 20 kHz, its volume can be reduced to one percent of its original volume (reach a cubic decimeter level), its power density is increased by about 100 times, and its efficiency is also slightly improved. These advantages make it have good prospects in the market of medium voltage power conversion systems. However, with the increase in power density and decrease in size of transformers, their reliability problems have become more prominent, and their service lives are greatly shortened. Because a medium voltage transformer is a core component of a system and bears almost all insulation stresses of the system, when its power density increases by a hundred times and a ground shielding layer has to be used because an air flash distance cannot be formed between a high-voltage winding and a low-voltage winding due to a decrease in overall size, the electrical stress at a connection terminal of the high-voltage winding surges, and its insulating layer is more prone to electrical aging failure caused by partial discharge, ultimately becoming a main factor leading to long-term failure of the transformer. Therefore, it is necessary to control the electrical stress on the insulating layer of the transformer, so as to reduce the occurrence of partial discharge and prolong the service life of the transformer.

### SUMMARY

Based on the above problems of the prior art, the present inventive concept provides a transformer winding, including an outlet terminal, the outlet terminal including:
a lead wire of a winding conductor of the transformer winding;
an insulating layer wrapping the lead wire;
a ground shielding layer covering a side, close to the winding conductor, of the insulating layer; and
a stress grading material layer, which is made of a semi-conductive material, covers a side, away from the winding conductor, of the insulating layer, and is electrically connected to the ground shielding layer, where the stress grading material layer is impedance-matched with the insulating layer.

In some embodiments, the material of the stress grading material layer is a non-linear resistance material, a high dielectric material, or a medium resistance semi-conductive material.

In some embodiments, the material of the stress grading material layer is a non-linear resistance material, with a characteristic conductivity of 10⁻¹²-10⁻⁸ S/m and a non-linear coefficient of 1-15 mm/kV.

In some embodiments, the material of the stress grading material layer is a high dielectric material, with a dielectric constant of 20-30.

In some embodiments, the material of the stress grading material layer is a medium resistance semi-conductive material, with a conductivity of 10⁻⁸-10⁻⁵ S/m.

In some embodiments, the stress grading material layer laps with the ground shielding layer.

In some embodiments, a length of lapping is not less than 5 mm.

In some embodiments, the outlet terminal further includes an insulating adhesive tape, which is bound to an end, away from the winding conductor, of the stress grading material layer to fix the stress grading material layer.

In some embodiments, the outlet terminal further includes a protective layer, which is wrapped on an outermost side of the outlet terminal.

In some embodiments, the protective layer has an umbrella skirt structure.

In some embodiments, the protective layer is an insulating tape or a cold shrink protective sleeve.

In some embodiments, the stress grading material layer is a stress grading tape or a stress grading coating layer.

The present inventive concept further provides a method for constructing the foregoing transformer winding, the method including:
determining a minimum length of the outlet terminal based on a minimum creepage distance under a design voltage;
obtaining along-surface electric field strength distributions of the outlet terminal under different lengths of the stress grading material layer based on a finite element analysis method and based on a characteristic conductivity, non-linear coefficient, dielectric constant, and thickness of the stress grading material layer and a thickness of the insulating layer; and
obtaining a shortest length of the stress grading material layer, so that the along-surface electric field strength of the outlet terminal is less than an upper limit threshold.

According to the transformer winding and the method for constructing the transformer winding in the present inventive concept, the stress grading material layer is electrically connected to the ground shielding layer of the outlet terminal, so that the along-surface potential change on the outer surface of the outlet terminal is slower and the along-surface electric field strength is lower, thereby reducing electric field distortion. The stress grading material can be directly wrapped or coated onto the surface of the insulating layer during use, without cooperating with a complex geometric structure, and with low power density loss.

### BRIEF DESCRIPTION OF THE DRAWINGS

FIG. 1 illustrates a schematic diagram of a three-junction effect in an insulating system.

FIG. 2A illustrates a schematic diagram of a transformer winding in the prior art.

FIG. 2B illustrates a cross-sectional diagram of the transformer winding in FIG. 2A along line A-A′.

FIG. 2C illustrates a planar diagram at the cross-section in FIG. 2B.

FIG. 3 illustrates a schematic diagram of electric field distortion at a ground shielding layer.

FIG. 4 illustrates a one-dimensional equivalent link model of an outlet terminal.

FIG. 5 illustrates a planar diagram of a transformer winding at a cross-section along line A-A′ shown in FIG. 2A according to an embodiment of the present inventive concept.

FIG. 6 illustrates a cross-sectional diagram of a transformer winding according to a second embodiment of the present inventive concept.

FIG. 7 illustrates a cross-sectional diagram of an outlet terminal of a transformer winding according to a third embodiment of the present inventive concept.

FIG. 8 illustrates a cross-sectional diagram of an outlet terminal of a transformer winding according to a fourth embodiment of the present inventive concept.

FIG. 9 illustrates a flowchart of a method for constructing an outlet terminal of a transformer winding according to an embodiment of the present inventive concept.

FIG. 10 illustrates electric field distributions of outlet terminals without a stress grading material and with two typical stress grading materials at 18 kV.

FIG. 11 illustrates potential distributions of outlet terminals without a stress grading material and including two typical stress grading materials at 18 kV.

FIG. 12 illustrates electric field distributions of outlet terminals with two typical stress grading materials at 35 kV.

FIG. 13 illustrates potential distributions of outlet terminals with two typical stress grading materials at 35 kV.

### DETAILED DESCRIPTION

In order to make the objectives, technical solutions and advantages of the present inventive concept clearer, the following will further describe the present inventive concept in detail in conjunction with the accompanying drawings through specific embodiments. It should be noted that the embodiments provided in the present inventive concept are for illustration purposes only and do not limit the scope of protection of the present inventive concept.

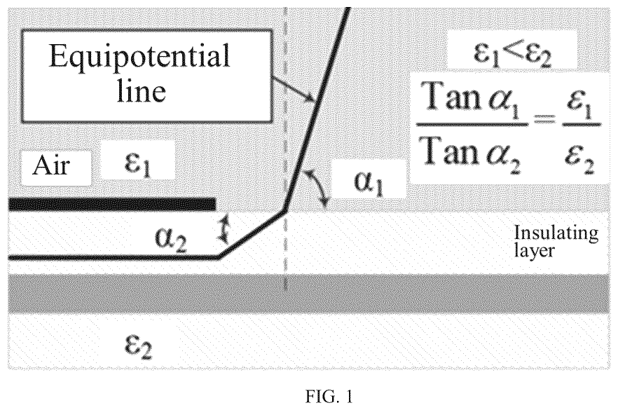

Main components of a transformer include a high-voltage winding, a low-voltage winding, and an iron core. Partial discharge generally occurs in the high-voltage winding, including partial discharge in an insulating layer and air corona discharge at an interface of the insulating layer. The partial discharge in the insulating layer is mainly caused by casting process defects. Generally, a shielding layer of a semiconductor material is added in the insulating layer to reduce the electric field strength in the insulating layer and avoid partial discharge caused by bubbles in the insulating layer. The air corona discharge at the interface of the insulating layer is mainly caused by the three-junction effect of an insulating system. As shown in FIG. 1, when a dielectric at an interface of an insulating structure has a large difference in dielectric constant, an equipotential line at the interface will bend. When the curvature of the bend is too large, that is, the electric field strength exceeds a corona trigger threshold of air, corona discharge will occur, and the generated heat and electrochemical changes will damage the insulating layer and accelerate the aging and failure of the insulating layer.

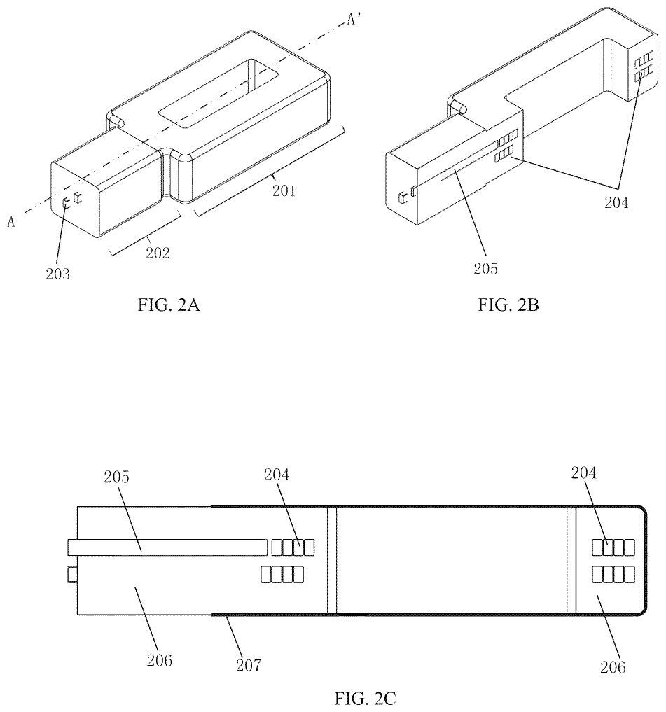

In order to prevent the corona discharge, the usual practice is to attach a grounded semi-conductive material layer to an outer side of the interface of the insulating layer, so as to reduce the difference in dielectric constant at the interface and shield the electric field of the main insulating layer to reduce the electric field strength at the interface to zero. FIG. 2A illustrates a schematic diagram of a transformer winding in the prior art, FIG. 2B illustrates a cross-sectional diagram of the transformer winding in FIG. 2A along line A-A′, and FIG. 2C illustrates a planar diagram at the cross-section in FIG. 2B. As shown in FIG. 2A to FIG. 2C, the transformer winding includes a ring winding portion 201, an outlet terminal 202, and a connection terminal 203. The ring winding portion 201 includes a winding conductor 204, an insulating layer 206 wrapping the winding conductor 204, and a ground shielding layer 207 covering the insulating layer 206. The outlet terminal 202 includes a lead wire 205, an insulating layer 206 wrapping the lead wire 205, and a ground shielding layer 207 partially covering the insulating layer 206. The connection terminal 203 is used for being connected to an external power source or load.

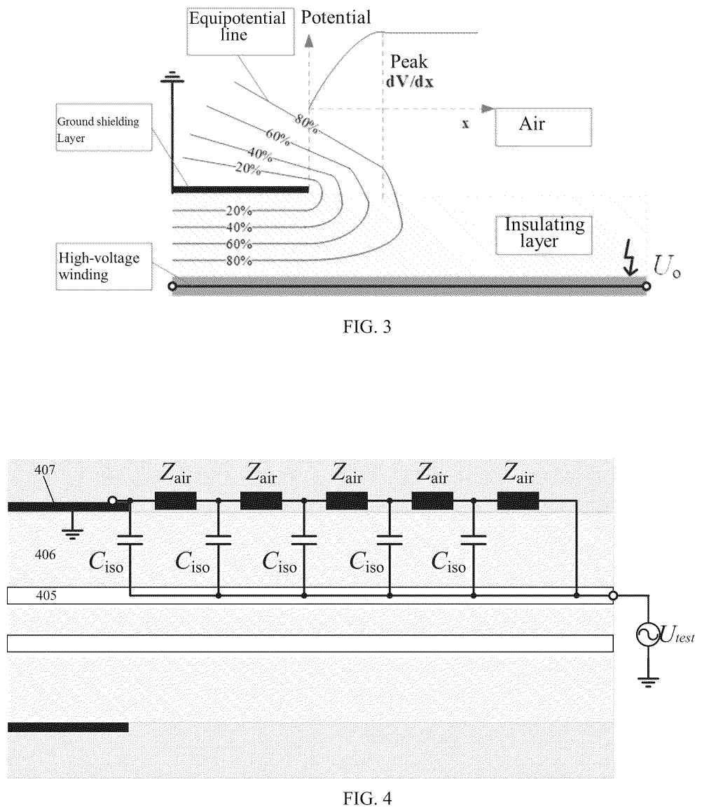

However, at the outlet terminal 202, because a suitable distance needs to be kept between the ground shielding layer 207 and the connection terminal 203 to prevent terminal discharge, there is still electric field distortion caused by the three-junction effect at an interface of the insulating layer exposed to air at a cut-off point of the ground shielding layer 207, as shown in FIG. 3.

A peak electric field along a surface of the insulating layer at the outlet terminal is located near a tail end of the ground shielding layer, which is caused by rapid rise in the along-surface potential. FIG. 4 illustrates a one-dimensional equivalent link model of an outlet terminal, showing a ground shielding layer 407, an insulating layer 406, and a lead wire 405. Uₜₑₛₜ is a test or operating voltage value, Cᵢₛₒ is volume capacitance of the insulating layer per unit length, and Zₐᵢᵣ is impedance of a surface air thin layer per unit length. Air has a relative dielectric constant of about 1 and resistivity of about 3×10¹³ Ω·m, so the impedance Zₐᵢᵣ of air can be equivalent to its capacitance Cₐᵢᵣ. The insulating layer 406 has a relative dielectric constant of about 4 and resistivity of more than 10¹⁶ Ω· m, and can be simplified as a capacitor structure, and compared to air, Cᵢₛₒ>Cₐᵢᵣ. Therefore, the air thin layer with smaller capacitance in the series capacitor structure has larger impedance, resulting in a rapid increase in voltage along the surface of the insulating layer 406 to distort electric field distribution and suddenly increase field strength. Therefore, the inventor found, in order to alleviate the electrical stress along the surface of the insulating layer, on the one hand, the equivalent impedance of the insulating layer can be increased, that is, the capacitance Cᵢₛₒ of the insulating layer can be reduced; and on the other hand, the impedance of a surface layer (namely, a layer in contact with the insulating layer, such as an air layer) can be reduced to achieve impedance matching between the two, thereby reducing the rate of potential drop, decreasing the strength of an along-surface electric field, and reducing electric field distortion.

FIG. 5 illustrates a planar diagram of a transformer winding at a cross-section along line A-A′ shown in FIG. 2A according to an embodiment of the present inventive concept. The transformer winding includes a ring winding portion 501, an outlet terminal 502, and a connection terminal 503. The ring winding portion 501 includes a winding conductor 504, an insulating layer 506 wrapping the winding conductor 504, and a ground shielding layer 507 covering the insulating layer 506. The outlet terminal 502 includes a lead wire 505 of the winding conductor 504; an insulating layer 506 wrapping the lead wire 505; a ground shielding layer 507 covering a side, close to the winding conductor, of the insulating layer; and a stress grading material layer 508 covering a side, away from the winding conductor, of the insulating layer and electrically connected to the ground shielding layer 507, where the stress grading material layer is impedance-matched with the insulating layer. The connection terminal 503 is used for being connected to an external power source or load. The stress grading material layer 508 electrically connected to the ground shielding layer 507 can effectively reduce the impedance of a surface layer to achieve impedance matching between the stress grading material layer and the ground shielding layer, thereby reducing the speed of along-surface potential changes of the insulating layer, reducing the strength of an along-surface electric field, and reducing electric field distortion. In the present inventive concept, the term “along-surface” is used for describing along an outer surface of the outlet terminal 502. The term “impedance matching” in the present inventive concept is used for describing impedance matching between the stress grading material layer and the insulating layer can avoid electric field distortion caused by the three-junction effect at the interface of the insulating layer.

The stress grading material layer includes an electrical stress grading (SG) material, which is a semi-conductive material, including but not limited to a non-linear resistance material, a high dielectric material, or a medium resistance semi-conductive material.

A conductivity of the stress grading material can be described as:

$${σ}_{SG} ( E ) = {σ}^{*} \times {e}^{\vert E \vert \times β} \qquad ( 1 )$$

Here, σ_{SG}(E) is the conductivity of the stress grading material when the electric field strength is E, |E| is a modulus of the electric field strength, the characteristic conductivity σ* is a conductivity when an applied electric field is 0, and B is a non-linear coefficient. For the non-linear resistance material, the non-linear coefficient β is not zero, and the conductivity of the stress grading material increases with the increase of an electric field. For the high dielectric material and the medium resistance semi-conductive material, the non-linear coefficient β is equal to zero, and the conductivity of the materials does not change with electric field environments.

In some embodiments, the characteristic conductivity σ* of the non-linear resistance material ranges from 10⁻¹² to 10⁻⁸ S/m, and its non-linear coefficient β ranges from 1 to 15 mm/kV, such as silicon carbide and zinc oxide.

In some embodiments, the dielectric constant of the high dielectric material ranges from 20 to 30.

In some embodiments, the conductivity σ_{SG} of the medium resistance semi-conductive material ranges from 10⁻⁸ to 10⁻⁵ S/m.

In some embodiments, the stress grading material layer may be either a stress grading tape or a stress grading coating layer, the stress grading tape is semi-overlap wound on the surface of the insulating layer at the outlet terminal or the stress grading coating layer is coated on the surface of the insulating layer at the outlet terminal, and the stress grading material layer is electrically connected to the ground shielding layer. For the non-adhesive stress grading tape, the gaps can be filled by vacuum impregnation cooperating with epoxy resin after overlap winding. In some embodiments, the stress grading material layer has a length of 5-15 cm.

In some embodiments, the winding conductor is a Litz wire, a copper foil, or an enameled flat wire.

In some embodiments, the ground shielding layer is a semi-conductive coating layer or semi-conductive tape, with a resistivity of 10⁻¹-10⁴ Ω*m.

In some embodiments, the insulating layer includes an inter-turn insulating layer of the winding conductor, as well as an insulating tape wrapping layer and an insulating casting layer outside the winding conductor.

In the above embodiments, the transformer winding only shows an insulating layer and a ground shielding layer, but those skilled in the art should understand that the transformer may include other layers in practical applications. For example, in patent CN114792598A, a ring winding portion and an outlet terminal of a transformer winding include a first insulating layer, a first semi-conductive layer, a second insulating layer, and a second semi-conductive layer (namely, a ground shielding layer). Such ring winding portion and outlet terminal structure also fall within the scope of protection of the present inventive concept. That is, in the present inventive concept, the term “wrapping” includes direct wrapping and indirect wrapping through other layers.

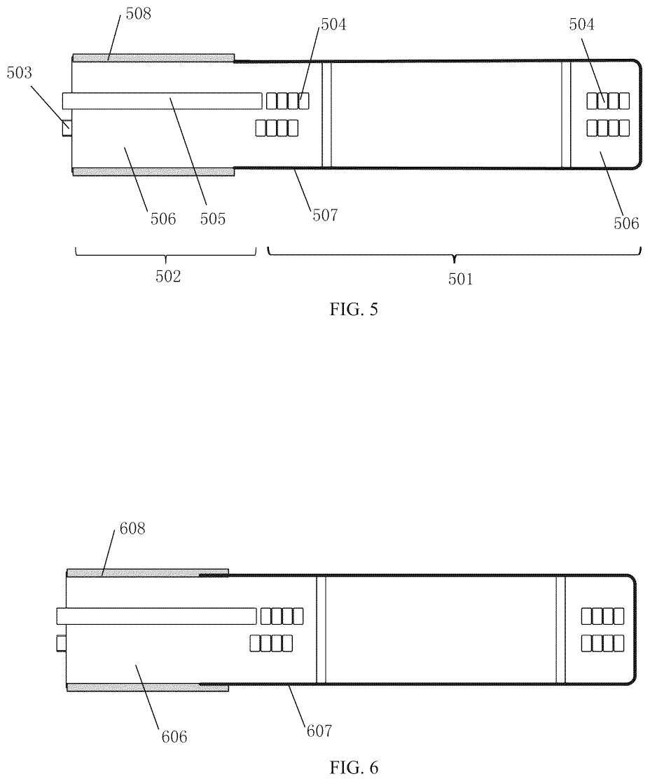

FIG. 6 illustrates a cross-sectional diagram of a transformer winding according to a second embodiment of the present inventive concept. The same part as FIG. 5 will not be repeated here. In this embodiment, the stress grading material layer 608 covers a side, away from the winding conductor, of the insulating layer 606, and laps with the ground shielding layer 607 to ensure electrical connection. The stress grading material layer 608 can lap on the exterior of the ground shielding layer 607, or between the ground shielding layer 607 and the insulating layer 606. In some embodiments, a length of lapping is not less than 5 mm, preferably not less than 1 cm.

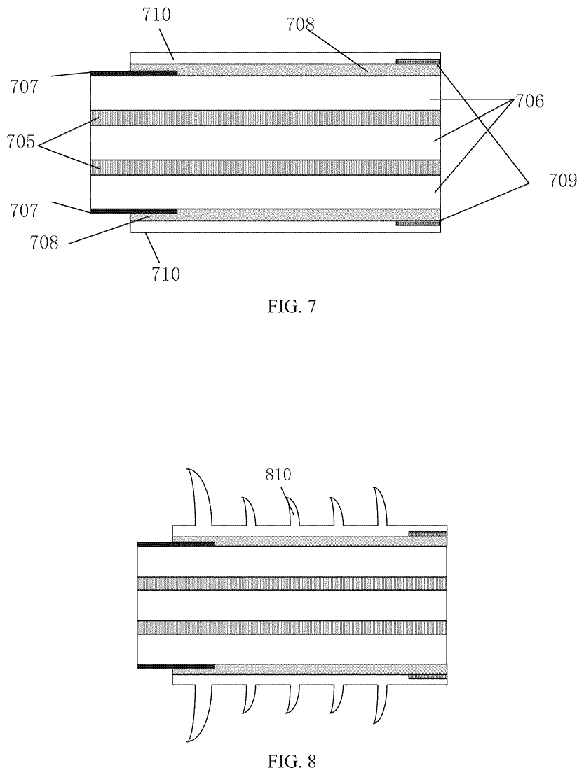

FIG. 7 illustrates a cross-sectional diagram of an outlet terminal of a transformer winding according to a third embodiment of the present inventive concept. The outlet terminal includes a lead wire 705 of a winding conductor; an insulating layer 706 wrapping the lead wire 705; a ground shielding layer 707 covering a side, close to the winding conductor, of the insulating layer; a stress grading material layer 708 covering a side, away from the winding conductor, of the insulating layer and lapping with the ground shielding layer 707 to ensure electrical connection; an insulating adhesive tape 709 tightly bound to an end, away from the winding conductor, of the stress grading material layer 708 to fix the stress grading material layer 708; and a protective layer 710 wrapped outside the stress grading material layer 708 and the insulating adhesive tape 709 to protect the stress grading material layer 708 from wear and aging. In some embodiments, the protective layer is an insulating tape or a cold shrink protective sleeve. In the embodiment where the stress grading material layer 708 can be fixed to the insulating layer 706, the insulating adhesive tape 709 can be omitted.

FIG. 8 illustrates a cross-sectional diagram of an outlet terminal of a transformer winding according to a fourth embodiment of the present inventive concept. The same part as FIG. 7 will not be repeated here. In this embodiment, the protective layer 810 has an umbrella skirt structure to increase the creepage distance between the ground shielding layer and the connection terminal of the transformer winding. The creepage distance is a shortest path between two conductive components or between a conductive component and a device protection interface that is measured along an insulating surface.

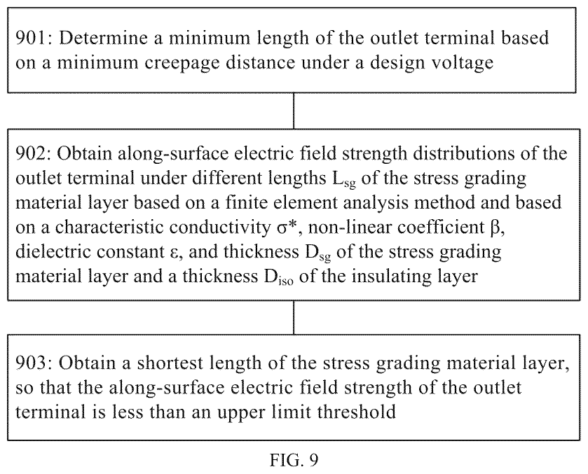

FIG. 9 illustrates a flowchart of a method for constructing an outlet terminal of a transformer winding according to an embodiment of the present inventive concept. The method includes:

Step 901: Determine a minimum length of the outlet terminal based on a minimum creepage distance under a design voltage.

Step 902: Obtain along-surface electric field strength distributions of the outlet terminal under different lengths L_{sg} of the stress grading material layer based on a finite element analysis method and based on a characteristic conductivity σ*, non-linear coefficient β, dielectric constant ε, and thickness D_{sg} of the stress grading material layer and a thickness Dᵢₛₒ of the insulating layer.

Step 903: Obtain a shortest length of the stress grading material layer, so that the along-surface electric field strength of the outlet terminal is less than an upper limit threshold.

Specifically, a maximum value of the along-surface electric field strength of the outlet terminal is compared with the upper limit threshold of the field strength; and if the maximum value of the electric field strength is greater than the upper limit threshold, the length L_{sg} of the stress grading layer needs to be further increased until the maximum value of the along-surface electric field strength is less than the upper limit threshold, so as to obtain the shortest length of the stress grading material layer.

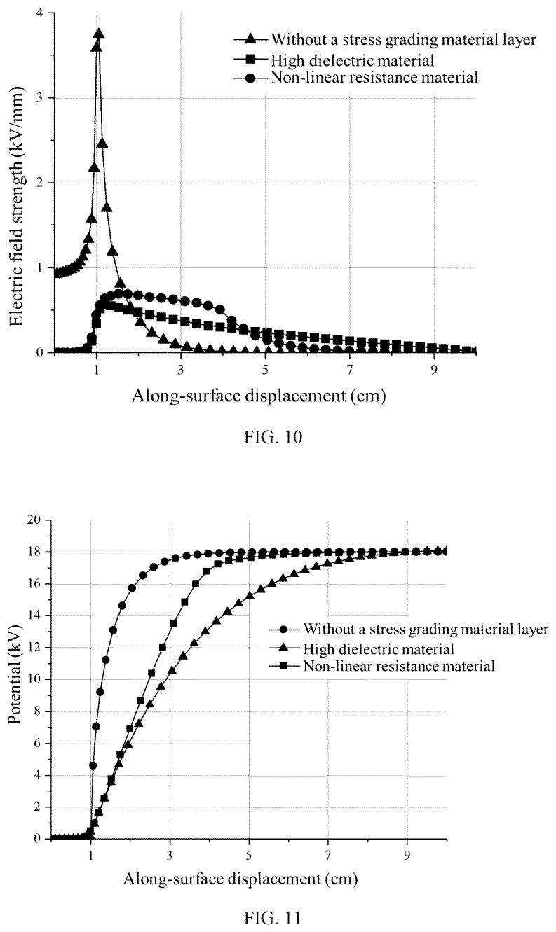

FIG. 10 illustrates electric field distributions of outlet terminals without a stress grading material and with two typical stress grading materials at 18 kV. It shows along-surface electric field strengths of the outlet terminals. It can be seen from FIG. 10 that the outlet terminal including a stress grading material layer has lower along-surface electric field strength. FIG. 11 illustrates potential distributions of outlet terminals without a stress grading material and including two typical stress grading materials at 18 kV. It can be seen from FIG. 11 that the outlet terminal including a stress grading material layer has slower changes in along-surface potential and smaller electric field distortion.

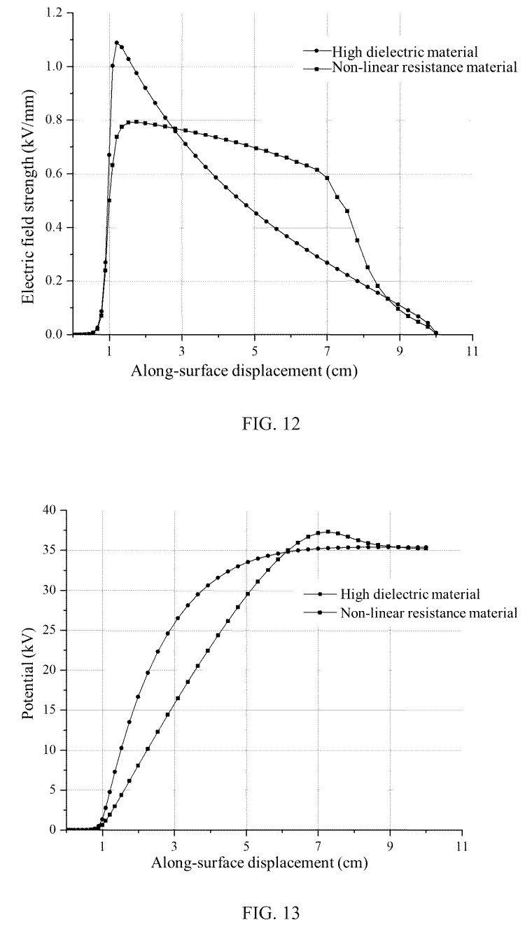

FIG. 12 illustrates electric field distributions of outlet terminals with two typical stress grading materials at 35 kV. It shows along-surface electric field strengths of the outlet terminals. It can be seen from FIG. 12 that the outlet terminal including a stress grading material layer has very low along-surface electric field strength. FIG. 13 illustrates potential distributions of outlet terminals with two typical stress grading materials at 35 kV. It can be seen from FIG. 13 that the outlet terminal including a stress grading material layer has very slow changes in along-surface potential and smaller electric field distortion.

In some embodiments, the outlet terminal of the transformer winding and the method for constructing the outlet terminal of the transformer winding in the present inventive concept are mainly applied to a voltage range of 10-35 KV.

According to the transformer winding and the method for constructing the transformer winding in the present inventive concept, the stress grading material layer is electrically connected to the ground shielding layer of the outlet terminal, so that the along-surface potential change on the outer surface of the outlet terminal is slower and the along-surface electric field strength is lower, thereby reducing electric field distortion. The stress grading material can be directly wrapped or coated onto the surface of the insulating layer during use, without cooperating with a complex geometric structure, and with low power density loss.

Although the present inventive concept is described through preferred embodiments, the present inventive concept is not limited to the embodiments described herein, but further includes various changes and variations made without departing from the scope of the present inventive concept.

### Terminology

Although this disclosure has been described in the context of certain embodiments and examples, it will be understood by those skilled in the art that the disclosure extends beyond the specifically disclosed embodiments to other alternative embodiments and/or uses and obvious modifications and equivalents thereof. In addition, while several variations of the embodiments of the disclosure have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. For example, features described above in connection with one embodiment can be used with a different embodiment described herein and the combination still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this inventive concept may include, additional to its essential features described herein, one or more features as described herein from each other embodiment of the inventive concept disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A transformer winding, comprising:
an outlet terminal, the outlet terminal comprising:
a lead wire of a winding conductor of the transformer winding;
an insulating layer at least partially surrounding the lead wire;
a ground shielding layer disposed on a first side of the insulating layer, proximate to the winding conductor; and
a stress grading material layer disposed on a second side of the insulating layer, away from the winding conductor, wherein the stress grading material layer is made of a semi-conductive material, is electrically connected to the ground shielding layer, and is impedance-matched with the insulating layer.

2. The transformer winding of claim 1, wherein a material of the stress grading material layer is a non-linear resistance material, a high dielectric material, or a medium resistance semi-conductive material.

3. The transformer winding of claim 2, wherein the material of the stress grading material layer is a non-linear resistance material, with a characteristic conductivity of 10⁻¹²-10⁻⁸ S/m and a non-linear coefficient of 1-15 mm/kV.

4. The transformer winding of claim 2, wherein the material of the stress grading material layer is a high dielectric material, with a dielectric constant of 20-30.

5. The transformer winding of claim 2, wherein the material of the stress grading material layer is a medium resistance semi-conductive material, with a conductivity of 10⁸-10⁻⁵ S/m.

6. The transformer winding of claim 1, wherein the stress grading material layer overlaps with the ground shielding layer.

7. The transformer winding of claim 6, wherein a length of lapping is not less than 5 mm.

8. The transformer winding of claim 1, wherein the outlet terminal further comprises an insulating adhesive tape, which is bound to an end, away from the winding conductor, of the stress grading material layer to fix the stress grading material layer.

9. The transformer winding of claim 1, wherein the outlet terminal further comprises a protective layer, which is wrapped on an outermost side of the outlet terminal.

10. The transformer winding of claim 9, wherein the protective layer has an umbrella skirt structure.

11. The transformer winding of claim 9, wherein the protective layer is an insulating tape or a cold shrink protective sleeve.

12. The transformer winding of claim 1, wherein the stress grading material layer is a stress grading tape or a stress grading coating layer.

13. A method for constructing a transformer winding, the method comprising:
determining a length of an outlet terminal of the transformer winding based on a creepage distance corresponding to a design voltage;
obtaining along-surface electric field strength distributions of the outlet terminal under varying lengths of a stress grading material layer by performing a finite element analysis, the finite element analysis considering characteristic conductivity, non-linear coefficient, dielectric constant, and thickness of the stress grading material layer and an insulating layer; and
obtaining a length of the stress grading material layer such that the along-surface electric field strength at the outlet terminal is maintained below an upper limit threshold.

14. The method of claim 13, wherein the length of the outlet terminal is a minimum length of the outlet terminal of the transformer winding based on a minimum creepage distance corresponding to the design voltage.

15. The method of claim 13, wherein the outlet terminal comprises:
a lead wire of a winding conductor of the transformer winding;
the insulating layer at least partially surrounding the lead wire;
a ground shielding layer disposed on a first side of the insulating layer, proximate to the winding conductor; and
the stress grading material layer disposed on a second side of the insulating layer, away from the winding conductor, wherein the stress grading material layer is made of a semi-conductive material, is electrically connected to the ground shielding layer, and is impedance-matched with the insulating layer.

16. The method of claim 13, further comprising applying the stress grading material layer to the insulating layer, wherein the stress grading material layer is electrically connected to a ground shielding layer positioned on a side of the insulating layer proximal to a winding conductor.

17. The method of claim 13, wherein a material of the stress grading material layer is a non-linear resistance material, a high dielectric material, or a medium resistance semi-conductive material.

18. The method of claim 17, wherein the material of the stress grading material layer is a non-linear resistance material, with a characteristic conductivity of 10⁻¹²-10⁻⁸ S/m and a non-linear coefficient of 1-15 mm/kV.

19. The method of claim 13, wherein the material of the stress grading material layer is a high dielectric material, with a dielectric constant of 20-30.

20. The method of claim 13, wherein the material of the stress grading material layer is a medium resistance semi-conductive material, with a conductivity of 10⁸-10⁻⁵ S/m.
